(19) United States
(12) Patent Application Publication
(10) Pub. No.: US 2026/0156436 A1
(43) Pub. Date: Jun. 4, 2026

(54) METHODS AND APPARATUSES FOR CONTROLLING FEDERATED LEARNING BEING PERFORMED BY A FLOCK OF WIRELESS DEVICES

(71) Applicant: Telefonaktiebolaget LM Ericsson (publ), Stockholm (SE)

(72) Inventors: Zhang FU, Stockholm (SE); Maria Belen PANCORBO MARCOS, Madrid (ES); Antonio INIESTA GONZALEZ, Madrid (ES); Jing YUE, Danderyd (SE)

(73) Assignee: Telefonaktiebolaget LM Ericsson (publ), Stockholm (SE)

(21) Appl. No.: 19/099,923

(22) PCT Filed: Aug. 8, 2023
(86) PCT No.: PCT/EP2023/071897

§ 371 Date: Jan. 30, 2025

(30) Foreign Application Priority Data
Aug. 8, 2022 (EP) 22382768.4

(51) Int. Cl. H04W 4/08; H04L 41/5009; H04W 48/16

(52) U.S. Cl. CPC H04W 4/08; H04L 41/5009; H04W 48/16

(57) ABSTRACT

Embodiments described herein relate to methods and apparatuses for controlling a group of wireless devices acting as a flock. A method in an analytics consumer service provider comprises transmitting a request to a core network function for information 5 indicating which wireless devices in the group are receiving a highest and/or lowest QoS performance.

### TECHNICAL FIELD

Embodiments described herein relate to methods and apparatuses for controlling federated learning being performed by a group of wireless devices. In particular, methods and apparatuses herein relate to the transfer of information relating to which wireless devices in the group are receiving a highest or lowest QoS performance.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

### Background On Group Performance “Flocking” Use Case

The below description of flocking is based on section 7.4 in TR 22.874 v18.2.0 which defines the group performance for a “Flocking” use case:

A new ‘service enabler’ is introduced that allows a service provider to achieve effective performance for an entire group of wireless devices. The term ‘Flock’ stands for a group associated with performance requirements that consider the performance ‘as a team’ as opposed to the ‘total’ or results of the ‘best performers.’

The example of a Flock provided in this use case (an application of this service enabler) is for Synchronous Federated Learning performed by a group of wireless devices. Please note that “Flocking” is a general service enabler. The application to Synchronous Federated Learning is just an example of where Flocking may be applied.

Synchronous federated learning involves a set of contributing terminals. In a federation, a hierarchy exists that provides an effective delegation of work and information. This federation functions as if it were a single (non-federated) system to the extent that the distributed components can operate within the same expectations. For synchronous federated learning, some number of the federation's components lag, these become stragglers. Information and function availability of the whole federation suffers when the performance of individual components fall significantly behind the others as the entire group should complete the iteration.

Synchronous federated learning works best by eliminating bias—allowing diverse users and devices to participate and bring to the learning task diversity of input data, as the users will have different attributes. It is important not to merely focus on the ‘best performing devices’ in the federation and drop the rest. Dropping stragglers may increase the performance in terms of time to iterate the synchronous federated learning task, but this will reduce the diversity of the data set and introduce bias.

Where group performance is defined by the weakest member (as in the slowest flying bird), we term this a “flock.” The 5GS normally considers performance objectives and QoS for individual communicating terminals. Here, the 5GS QoS objective relates to the entire set of terminals making up the federation, the “flock” of User Equipments (UEs) (also referred to herein as wireless devices).

A set of wireless devices that participate in federated learning exists. These wireless devices have registered with a Public Land Mobile Network (PLMN) and operate in a federation to perform federated learning tasks. A federated learning service provider, for example, “Avian” organizes the work of these wireless devices so that repeated iterations of training will occur over time.

It may be assumed that the wireless devices provide federated learning input using the same network resources (e.g. a network slice) and that a policy for this network communication is distinct from a policy for other activities that each wireless device performs. In this way, the network can adjust the QoS policy for federated learning communication for individual wireless devices without any service impact except to the federated learning service.

The ‘flock’ of wireless devices may be considered to perform consistently. The existing QoS features controlled by the network with reconfigurable policy provide necessary but not sufficient functionality to support the use case. The 5G system may be updated to support ‘aggregated performance’ for a group of wireless devices where the worst performing member defines the performance of the entire group. For example, the 5G system may be configured to achieve performance for the entire group so as to avoid members achieving either significantly less or more performance than others in the group. The 5G system may be configured to determine whether a required QoS for each member in a group can be maintained. The 5G system may be configured to expose QoS information for a group of UEs to an authorized service provider. The 5G core network may be configured to support collection of charging information based on whether the traffic is for Artificial Intelligence or Machine Learning (AI/ML) services.

### Background on an AI/ML Study

To reflect on the service requirement from TR 22.874 v 18.2.0 and TS 22.261 v 18.6.1, TR 23.700-80 v 0.3.0 defines key issues (e.g. Key issue #7) to address the group performance monitoring and exposure for the AI/ML application.

### Key Issue (KI) #7: 5GS Assistance to Federated Learning (FL) Operation

This KI is to study whether and how 5G System provides assistance to an application function (AF) and a UE for the AF and UE to manage the FL operation and model distribution/redistribution (i.e. FL member selection, group performance monitoring, adequate network resources allocation and guarantee) to facilitate collaborative Application AI/ML based Federated Learning operation between the application clients running on the UEs and the Application Servers.

In order to provide assistance to the AF and the wireless device for FL operations, it is proposed to study the following aspects:
1) On assistance to selection of wireless devices for FL operation:
   Whether, how and what information provided by the 5G Core (5GC) to the Application Function (AF) can help the AF to select and manage the group of wireless devices which will be part of FL operation. The FL group management may be controlled and managed by the AF.
   Whether, how and what information is required by the 5GC in order to assist the AF for selecting and managing the group of wireless devices which will be part of FL operation.
On performance monitoring/exposure:
   How to monitor and expose a wireless device or a group of wireless devices performance (e.g. aggregated QoS parameters) as described in TS 22.261 v18.6.1 related to FL operations.
   Whether and what existing or new monitoring events (e.g., QoS, location, load, congestion) are required to capture specific System Performance and Predictions for traffic related to AI/ML operations for FL operation.
On FL performance:
   How to assist the AF to increase the FL performance (e.g., to manage latency divergence) among wireless devices when the application server receives the local ML model training information from different wireless devices in order to perform a global model update.

### SUMMARY

According to some embodiments there is provided a method in an analytics consumer service provider for controlling a group of wireless devices acting as a flock. The method comprises transmitting a request to a core network function for information indicating which wireless devices in the group are receiving a highest and/or lowest QoS performance.

According to some embodiments there is provided a method in a core network function for providing data network performance analytics to an analytics consumer service provider that is controlling a group of wireless devices acting as a flock. The method comprises receiving a request from the analytics consumer service provider for information indicating which wireless devices in the group are receiving the highest and/or lowest QoS performance.

According to some embodiments there is provided an analytics consumer service provider for controlling a group of wireless devices acting as a flock. The analytics consumer service provider comprises processing circuitry configured to cause the analytics consumer service provider to transmit a request to a core network function for information indicating which wireless devices in the group are receiving a highest and/or lowest QoS performance.

According to some embodiments there is provided a core network function for providing data network performance analytics to an analytics consumer service provider that is controlling a group of wireless devices acting as a flock. The core network function comprises processing circuitry configured to cause the core network function to: receive a request from the analytics consumer service provider for information indicating which wireless devices in the group are receiving the highest and/or lowest QoS performance.

Aspects and examples of the present disclosure thus provide methods and apparatuses that allow for 5GS to adjust QoS policies of wireless devices in a flock to allocate more resources for those wireless devices that lag, and less resources for those that are ahead of the flock. This may then improve the overall performance of the flock.

For the purposes of the present disclosure, the term “ML model” encompasses within its scope the following concepts:
Machine Learning algorithms, comprising processes or instructions through which data may be used in a training process to generate a model artefact for performing a given task, or for representing a real world process or system;
the model artefact that is created by such a training process, and which comprises the computational architecture that performs the task; and
the process performed by the model artefact in order to complete the task.

References to “ML model”, “model”, model parameters”, “model information”, etc., may thus be understood as relating to any one or more of the above concepts encompassed within the scope of “ML model”.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates a 5G Service Enabler interface;

FIG. 2 illustrates a method 200 of controlling a group of wireless devices acting as a flock;

FIG. 3 illustrates a method 300 providing data network performance analytics to an analytics consumer service provider that is controlling a group of wireless devices acting as a flock;

FIG. 4 illustrates an analytics consumer service provider comprising processing circuitry (or logic);

FIG. 5 is a block diagram illustrating an analytics consumer service provider 500 according to some embodiments;

FIG. 6 illustrates a core network function 600 comprising processing circuitry (or logic); and

FIG. 7 is a block diagram illustrating a core network function 700 according to some embodiments.

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

For performing FL using a group of wireless devices, the performance and quality of the output of the entire set of wireless devices is bounded by the performance of the weakest members of the group. An analytics consumer service provider, for example, Avian, may therefore provide the 5GS with a policy identifying the reporting interval for which different iterations should conclude. The analytics consumer service provider may also provide reports on the progress of different wireless devices as they proceed. The 5GS may then be in a position to adjust the QoS policies of some wireless devices to allocate more resources for those wireless devices that lag, and less resources for those that are ahead of the flock. Therefore, the slowest wireless devices (e.g. those producing a report after an iteration of a federated learning task) achieve an improved performance. The fastest wireless devices (e.g. those not producing a report after a federated learning task) do not need as much network resources (higher QoS), so the 5GS can reduce the QoS guarantees for these, and thereby save resources. The overall result is more efficient for the Synchronous Federated Learning service and for the network operator. The resource re-allocated to a wireless device may be maintained for at least one iteration.

It will be appreciated that, as described herein, an analytics consumer service provider may comprise any network node or function that is consuming analytics (e.g. from an NWDAF) and providing a service comprising controlling a group of wireless devices acting as a flock.

The 5GS may Inform, the analytics consumer service provider, e.g. Avian, of any additional wireless devices with good communication performance (e.g. due to radio resources) and/or existing wireless devices whose connection has degraded to a level which is no longer sufficient for FL tasks. This enables the analytics consumer service provider to determine when to add new wireless devices to the flock or to remove existing uEs from the flock.

While it is clear that the speed with which training occurs and reports are generated by wireless devices is only partially bounded by communication, it may be assumed that the communication resources available to each wireless device is a significant contributor to the time it requires to complete a training iteration.

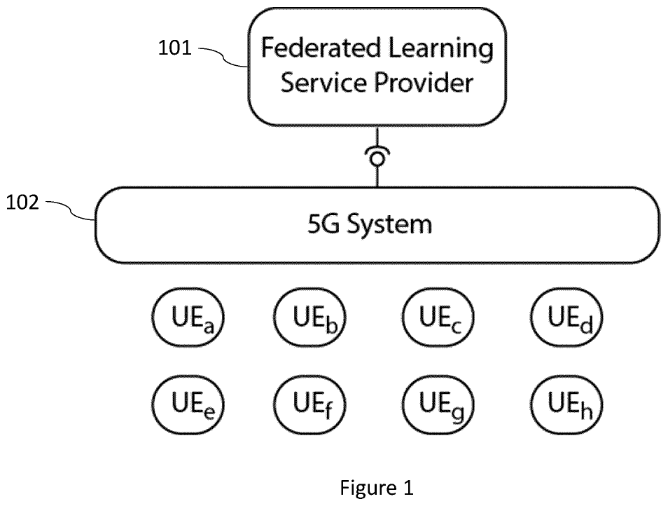

When a new wireless device joins the federation, it may register with the analytics consumer service provider, e.g. Avian. The analytics consumer service provider may then notify the 5GS (by means of a standard interface) of this addition. This interface is depicted logically in FIG. 1.

FIG. 1 illustrates a 5G Service Enabler interface. In particular, FIG. 1 illustrates an example of a 5G service enabler interface for Synchronous Federated Learning. The interface described above is illustrated between the federated Learning Service provider 101 (e.g. Avia) and the 5G System 102.

Similarly to when a wireless device joins the federation, when a wireless device leaves the federation, the 5GS may be notified (e.g. using the interface between the federated learning service provider 101 and the 5G system). This allows the 5GS to modify a quality of service (QoS) policy (e.g. what QoS parameters should be used for the AI/ML traffic of the UE) to balance the QoS policy to achieve the most consistent performance across the involved wireless devices. During the adjustment of the QoS policy, the total communication resources (e.g. total Guaranteed Bit Rate (GBR) of all members in the flock) may be allocated a maximum set of resources, (e.g. a GBR aggregate that should not exceed a maximum value).

As the data transmission for Federated Learning may not be for regular data services such as video, voice call, webpage browsing, etc., the 5GS 102 may need to have a charging exemption or charging reward associated with the kind of traffic.

### Solution 41 in TR 23.700-80 v 0.3.0

Solution #41 extends the Data Network (DN) performance analytics defined in TS 23.288 v 17.5.0 to solve the Key issue mentioned above in the background section:

### Solution #41: Solution for Supporting Aggregated UE Performance Monitoring and Exposure for a Group of uEs

This solution aims to address the key issue #7 above to support aggregated UE performance monitoring and exposure for a group of wireless devices (or uEs). The proposed solution is suitable for any group based AI/ML operations, including Federated Learning operations.

Regarding wireless device performance, focus may be placed on the QoS parameters, such as packet latency, traffic rate (e.g. bit rate), loss rate (e.g. packet drop rate). Those QoS parameters are already specified as part of the output parameters of DN Performance Analytics in clause 6.14 of TS 23.288 v17.5.0 . However, the output parameters of DN Performance analytics may be extended to include aggregated parameters.

Therefore, solution #41 proposes to add the following parameters in the output parameters of DN Performance Analytics:
aggregated traffic rate;
variance of the traffic rate;
variance of packet delay;
variance of packet loss rate.

The procedure is the same as clause 6.14.4 in TS 23.288 v17.5.0 , where the analytics consumer is the AF (via network exposure function (NEF)) and the Target of Analytics Reporting is a group of wireless devices which are participating the AIML operations.

The impacts on services, entities and interfaces includes that the output of the DN Performance Analytics is extended with more parameters.

According to TR 22.874 v 18.2.0 as mentioned above:

The 5GS can inform Avian of any additional wireless devices with good communication performance (e.g. due to radio resources) and/or existing wireless devices whose connection has degraded to a level which is no longer sufficient for FL tasks.

It is not enough to provide to the AF only the aggregated traffic rate and variance of the other QoS parameters, since the AF needs to know which wireless device in the group has been over provisioned and/or which wireless device in the group has low QoS.

Embodiments described herein propose to extend, for example, the DN performance analytics with information indicative of which wireless devices in the group (e.g. a top N, where N is an integer value) are associated with the highest/lowest packet latencies (or packet delays), drop rate (or loss rates), bit rate (or traffic rates), etc. The AF may then utilise this information to determine when to add new wireless devices into the flock (group) or remove existing wireless devices from the flock (group).

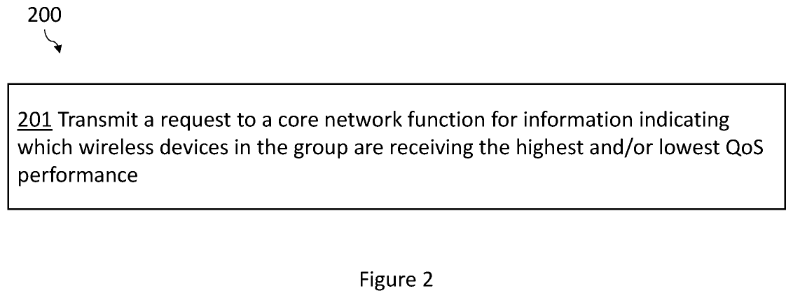

FIG. 2 illustrates a method 200 of controlling a group of wireless devices acting as a flock.

The method 200 may be performed by a network node, which may comprise a physical or virtual node, and may be implemented in a computing device or server apparatus and/or in a virtualized environment, for example in a cloud, edge cloud or fog deployment. In particular, the network node may comprise an analytics consumer service provider (e.g. Avian).

In step 201, the method comprises transmitting a request to a core network function for information indicating which wireless devices in the group are receiving a highest or lowest QoS performance. The QoS performance may comprise one or more of: a traffic rate, a packet delay and a traffic rate. The core network function may comprise a Network Data Analytics Function (NWDAF).

The request may be for information relating to which N, where N is an integer number, wireless devices in the group are receiving the highest or lowest QoS performance. For example, in some examples the analytics consumer service provider may request information relating to 3 or 4 wireless devices receiving the highest or lowest QoS performance, in which case N may be set to 3 or 4.

In some examples, the request is for information relating to which wireless devices in the group are receiving the highest QoS performance and which wireless devices in the group are receiving the lowest QoS performance.

In some examples, the request is transmitted as part of a subscription request subscribing to data network performance analytics.

In some examples, the method 200 further comprises, responsive to transmitting the request in step 201, receiving the information indicating which wireless devices in the group are receiving the highest and/or lowest QoS performance. The information may comprise User Equipment Identifiers (UE IDs) for the wireless devices that are receiving the highest and/or lowest QoS performance.

In some examples, the information is received at the analytics consumer service provider via a network exposure function, NEF. For example, the NEF may map the Subscription Permanent Identifiers (SUPIs) of the wireless devices in the group that are receiving the highest or lowest QoS performance to external User Equipment Identifications (which may be General Public Subscription Identifiers (GPSIs)) before forwarding the information to the analytics consumer service provider. In some examples, the NEF may use a Nudm_SDM_Get service operation.

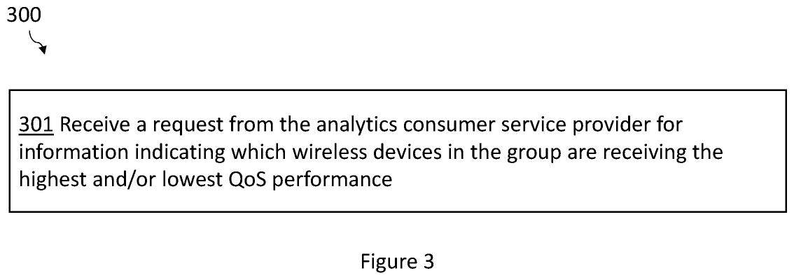

FIG. 3 illustrates a method 300 providing data network performance analytics to an analytics consumer service provider that is controlling a group of wireless devices acting as a flock.

The method 300 may be performed by a network node, which may comprise a physical or virtual node, and may be implemented in a computing device or server apparatus and/or in a virtualized environment, for example in a cloud, edge cloud or fog deployment. In particular, the network node may comprise core network function such as a Network Data Analytics Function (NWDAF).

In step 301 the method comprises receiving a request from the analytics consumer service provider for information indicating which wireless devices in the group are receiving the highest and/or lowest QoS performance. Step 301 may correspond to step 201 of FIG. 2. The QoS performance may comprise one or more of: a traffic rate, a packet delay and a loss rate.

In some examples the request in step 310 is for information relating to which N, where N is an integer number, wireless devices in the group are receiving the highest or lowest QoS performance.

In some example, the request is for information relating to which wireless devices in the group are receiving the highest QoS performance and which wireless devices in the group are receiving the lowest QoS performance.

The request may be transmitted as part of a subscription request subscribing to data network performance analytics.

In some examples, the method further comprises responsive to receiving the request, transmitting the information indicating which wireless devices in the group are receiving the highest or lowest QoS performance to the analytics consumer service provider. The information may be transmitted to the analytics consumer service provider via a network exposure function, NEF (for example as described above with reference to FIG. 2).

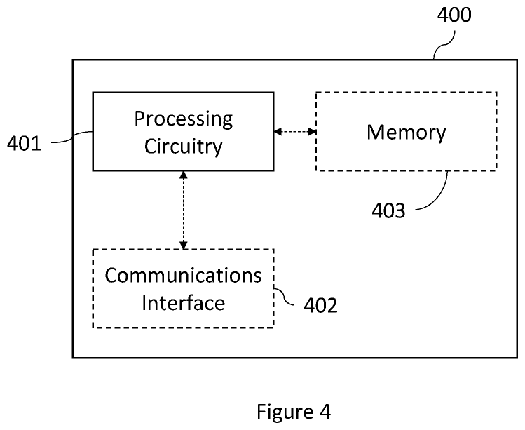

FIG. 4 illustrates an analytics consumer service provider 400 comprising processing circuitry (or logic) 401. The processing circuitry 401 controls the operation of the analytics consumer service provider 400 and can implement the method described herein in relation to an analytics consumer service provider 400. The processing circuitry 401 can comprise one or more processors, processing units, multi-core processors or modules that are configured or programmed to control the analytics consumer service provider 400 in the manner described herein. In particular implementations, the processing circuitry 401 can comprise a plurality of software and/or hardware modules that are each configured to perform, or are for performing, individual or multiple steps of the method described herein in relation to the analytics consumer service provider 400.

Briefly, the processing circuitry 401 of the analytics consumer service provider 400 is configured to: transmit a request to a core network function for information indicating which wireless devices in the group are receiving a highest and/or lowest QoS performance.

In some embodiments, the analytics consumer service provider 400 may optionally comprise a communications interface 402. The communications interface 402 of the analytics consumer service provider 400 can be for use in communicating with other nodes, such as other virtual nodes. For example, the communications interface 402 of the analytics consumer service provider 400 can be configured to transmit to and/or receive from other nodes requests, resources, information, data, signals, or similar.

The processing circuitry 401 of analytics consumer service provider 400 may be configured to control the communications interface 402 of the analytics consumer service provider 400 to transmit to and/or receive from other nodes requests, resources, information, data, signals, or similar.

Optionally, the analytics consumer service provider 400 may comprise a memory 403. In some embodiments, the memory 403 of the analytics consumer service provider 400 can be configured to store program code that can be executed by the processing circuitry 401 of the analytics consumer service provider 400 to perform the method described herein in relation to the analytics consumer service provider 400. Alternatively or in addition, the memory 403 of the analytics consumer service provider 400, can be configured to store any requests, resources, information, data, signals, or similar that are described herein. The processing circuitry 401 of the analytics consumer service provider 400 may be configured to control the memory 403 of the analytics consumer service provider 400 to store any requests, resources, information, data, signals, or similar that are described herein.

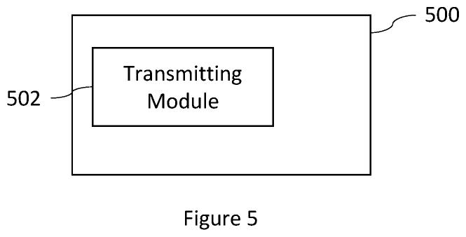

FIG. 5 is a block diagram illustrating an analytics consumer service provider 500 according to some embodiments. The analytics consumer service provider 500 comprises a transmitting module 502 configured to transmit a request to a core network function for information indicating which wireless devices in the group are receiving a highest and/or lowest QoS performance.

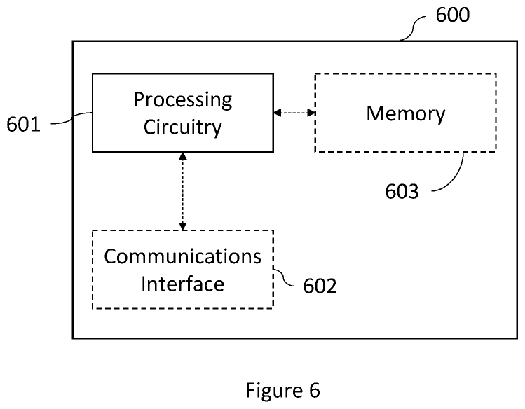

FIG. 6 illustrates a core network function 600 comprising processing circuitry (or logic) 601. The processing circuitry 601 controls the operation of the core network function 600 and can implement the method described herein in relation to an core network function 600. The processing circuitry 601 can comprise one or more processors, processing units, multi-core processors or modules that are configured or programmed to control the core network function 600 in the manner described herein. In particular implementations, the processing circuitry 601 can comprise a plurality of software and/or hardware modules that are each configured to perform, or are for performing, individual or multiple steps of the method described herein in relation to the core network function 600.

Briefly, the processing circuitry 601 of the core network function 600 is configured to: receive a request from the analytics consumer service provider for information indicating which wireless devices in the group are receiving the highest and/or lowest QoS performance.

In some embodiments, the core network function 600 may optionally comprise a communications interface 602. The communications interface 602 of the core network function 600 can be for use in communicating with other nodes, such as other virtual nodes. For example, the communications interface 602 of the core network function 600 can be configured to transmit to and/or receive from other nodes requests, resources, information, data, signals, or similar. The processing circuitry 601 of core network function 600 may be configured to control the communications interface 602 of the core network function 600 to transmit to and/or receive from other nodes requests, resources, information, data, signals, or similar.

Optionally, the core network function 600 may comprise a memory 603. In some embodiments, the memory 603 of the core network function 600 can be configured to store program code that can be executed by the processing circuitry 601 of the core network function 600 to perform the method described herein in relation to the core network function 600. Alternatively or in addition, the memory 603 of the core network function 600, can be configured to store any requests, resources, information, data, signals, or similar that are described herein. The processing circuitry 601 of the core network function 600 may be configured to control the memory 603 of the core network function 600 to store any requests, resources, information, data, signals, or similar that are described herein.

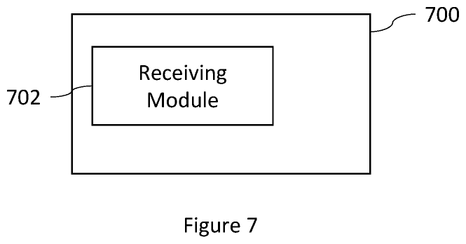

FIG. 7 is a block diagram illustrating a core network function 700 according to some embodiments. The core network function 700 comprises a receiving module 702 configured to receive a request from the analytics consumer service provider for information indicating which wireless devices in the group are receiving the highest and/or lowest QoS performance.

There is also provided a computer program comprising instructions which, when executed by processing circuitry (such as the processing circuitry 401 of the analytics consumer service provider 400 described earlier), cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-19. (canceled)

20. A method in an analytics consumer service provider for controlling a group of wireless devices acting as a flock, the method comprising:
transmitting a request to a core network function for information indicating which wireless devices in the group are receiving a highest and/or lowest QoS performance; wherein the QoS performance comprises one or more of: a traffic rate, a packet delay and a loss rate.

21. The method as claimed in claim 20, wherein the request is transmitted as part of a subscription request subscribing to data network performance analytics.

22. The method as claimed in claim 20 further comprising:
responsive to transmitting the request, receiving the information indicating which wireless devices in the group are receiving the highest or lowest QoS performance.

23. The method as claimed in claim 22, wherein the information is received via a network exposure function, NEF.

24. The method as claimed in claim 23, wherein the NEF maps Subscription Permanent Identifiers (SUPIs) of the wireless devices in the group that are receiving the highest or lowest QoS performance to external User Equipment Identifications (UE IDs) before forwarding the information to the analytics consumer service provider.

25. A method in a core network function for providing data network performance analytics to an analytics consumer service provider that is controlling a group of wireless devices acting as a flock, the method comprising:
receiving a request from the analytics consumer service provider for information indicating which wireless devices in the group are receiving the highest and/or lowest QoS performance; wherein the QoS performance comprises one or more of: a traffic rate, a packet delay and a loss rate.

26. The method as claimed in claim 25, wherein the request is transmitted as part of a subscription request subscribing to data network performance analytics.

27. The method as claimed in claim 25 further comprising:
responsive to receiving the request, transmitting the information indicating which wireless devices in the group are receiving the highest or lowest QoS performance to the analytics consumer service provider.

28. The method as claimed in claim 27, wherein the information is transmitted to the analytics consumer service provider via a network exposure function, NEF.

29. The method as claimed in claim 28, wherein the NEF maps Subscription Permanent Identifiers (SUPIs) of the wireless devices in the group that are receiving the highest or lowest QoS performance to external User Equipment Identifications (UE IDs) before forwarding the information to the analytics consumer service provider.

30. An analytics consumer service provider for controlling a group of wireless devices acting as a flock, the analytics consumer service provider comprising processing circuitry configured to cause the analytics consumer service provider to:
transmit a request to a core network function for information indicating which wireless devices in the group are receiving a highest and/or lowest QoS performance.

31. The analytics consumer service provider as claimed in claim 30, wherein the processing circuitry is further configured to cause the analytics consumer service provider to, responsive to transmitting the request, receive the information indicating which wireless devices in the group are receiving the highest or lowest QoS performance.

32. A core network function for providing data network performance analytics to an analytics consumer service provider that is controlling a group of wireless devices acting as a flock, the core network function comprising processing circuitry configured to cause the core network function to:
receive a request from the analytics consumer service provider for information indicating which wireless devices in the group are receiving the highest and/or lowest QoS performance.

33. The core network function as claimed in claim 32, wherein the processing circuitry is further configured to cause the core network function to, responsive to receiving the request, transmit the information indicating which wireless devices in the group are receiving the highest or lowest QoS performance to the analytics consumer service provider.
